(19) United States
(12) Patent Application Publication
(10) Pub. No.: US 2021/0381429 A1
(43) Pub. Date: Dec. 9, 2021

(54) AIRCRAFT PRIME MOVER

(71) Applicant: GKN Aerospace Services Limited, Redditch, Worcestershire (GB)

(72) Inventor: Simon Taylor, Redditch, Worcestershire (GB)

(21) Appl. No.: 17/284,918

(22) PCT Filed: Oct. 15, 2019
(86) PCT No.: PCT/GB2019/052934

§ 371 Date: Apr. 13, 2021

(30) Foreign Application Priority Data
Oct. 15, 2018 (GB) 1816767.6

(51) Int. Cl. F02C 3/00; F02C 1/00

(52) U.S. Cl. CPC F02C 3/00; F05D 2220/323; F02C 1/00

(57) ABSTRACT

A multi-source aircraft propulsion arrangement comprises a cryogenic propulsion source and a combustion propulsion source wherein the cryogenic propulsion source and the combustion propulsion source may be selectively and independently operated to generate propulsive force for an aircraft.

### CROSS-REFERENCE TO RELATED APPLICATIONS

This application is a national stage of, and claims priority to, Patent Cooperation Treaty Application No. PCT/GB2019/052934, filed on Oct. 15, 2019, which application claims priority to Great Britain Application No. GB 1816767.6, filed on Oct. 15, 2018, which applications are hereby incorporated herein by reference in their entireties.

### BACKGROUND

The present disclosure is concerned with aircraft propulsion systems and specifically to aircraft propulsion arrangements which are the cause of significant harmful gaseous emissions.

According to most estimates, airline traffic is set to double every fifteen years providing a significant increase in the operation of land-based and, subsequently, airborne propulsion systems and therefore the production of associated emissions. Emissions are known to be harmful whether produced at ground level or at altitude.

In order to meet targets for reduction of emissions set by the International Air Transport Association, the use of alternate fuels has been identified as a possible avenue of exploration. Alternate fuels include biofuels, synthetic kerosene, compressed natural gas. In addition, the ACARE roadmap for 2050 identifies the need and sets objectives for significant reductions for a range of emissions. It is widely recognised that the opportunities to come close to or achieve these targets are limited.

To solve these issues a number of propulsion systems have been employed in different aircraft. Most systems use fossil fuel sources for economic reasons and also due to their very high energy density and specific energy. The prevalence of the gas turbine has also led to fossil fuels being a desirable propulsion mechanism for aircraft. This has led to developments for improving the performance of fossil fuel burning gas turbines.

Current aircraft propulsion systems have evolved to use two or more engines where fuel is supplied from fuel tanks, which may be located within the wings, to the engines. The vast majority of aircraft systems operate using this arrangement, indicating that this arrangement has become the industry's preferred solution to generating propulsion. In combination with advances in aero-engine performance and fuel economy the emissions levels have been reduced.

However, a drawback of such propulsion systems is that the geometry of the aircraft is constrained which may include any of the landing gear locations and dimensions, engine pylon aerodynamics and the use of gull wings.

Investigations have been made into the use of alternative, sustainable and more environmentally friendly fuels including natural gas and hydrogen. A hydrogen powered aircraft was flown in 1957 as the Martin Canberra B57. In 1988, Russian manufacturer Tupolev converted a Tu154 into the 155 as a demonstrator of the possible use of liquid hydrogen (LH₂) and liquid natural gas (LNG). Later hydrogen developments have been hindered by the spatial requirements of hydrogen (H₂), typically too much volume needs to be occupied in the aircraft by tanks containing H₂ for this to be a viable solution. LH₂, however, has a more beneficial volumetric energy density than H₂.

By requiring larger volumes of H₂ or LH₂ to produce the same energy, in comparison to fossil fuels, larger storage tanks are required. A solution to this storage issue has been employed which involves locating large liquid hydrogen tanks along the top of the aircraft fuselage.

This solution however has a consequential detrimental impact upon the drag of the fuselage by increasing both the wetted, and cross-sectional, areas. Further complications arise from this arrangement by potentially requiring a complex longitudinal pressure boundary which extends along the length of the fuselage.

Current tank configurations include tube and wing configurations, wherein the tanks are held in the wings and the fuselage. Such tube and wing configurations are widely prevalent for commercial aircraft. This design is, however, not congruous with the current preference for higher aspect ratio and lower thickness wings in order to reduce lift-induced drag and to enable higher levels of natural laminar flow. Clearly, the smaller the tank volume the more easily achievable these preferences are. As such, these preferences are highly challenging to obtain using H₂ or LH₂.

Therefore, despite these advances, there remain a number of problems that have affected aircraft reduction in emissions. The inventors of an invention described herein have however created an alternative propulsion arrangement which has a wide range of previously unavailable advantages which are described herein.

### SUMMARY

Viewed from first aspect there is provided an aircraft propulsion arrangement comprising a cryogenic source, wherein the cryogenic source may be selectively and independently operated to generate propulsive force for an aircraft by combustion and/or to generate propulsive force for an aircraft by electrical energy generation.

Thus, according to this disclosure aircraft propulsion can be provided with a reduction in emissions of 30% over modern systems. This in turn reduces the environmental impact of air flight.

Furthermore, the cryogenic source may be used to improve electrical signalling so as to further improve the efficiencies associated with power generation and transferral in air flight.

Enabling selection of the method of power generation of an aircraft enables a pilot to select the most suitable propulsion method for particular stages of air travel. In this way, a method of propulsion that produces lower amounts of harmful emissions may be used on taxiing, take off and landing so that emissions are not produced at ground level in populated areas. This in turn reduces the environmental impact of air flight in populated areas.

Similarly selective propulsion enables a pilot to increase propulsion during flight in for example an environment requiring greater thrust.

Viewed from another aspect there is provided a cryogenic system in an aircraft prime mover system arranged to drive a prime mover as part of a distributed propulsion system, wherein the cryogenic system comprises a cryogen container arranged in use to contain a cryogen.

Viewed from yet another aspect there is provided an aircraft prime mover system comprising: at least one combustion prime mover; at least one cryogenic prime mover; and a cryogenic system comprising a cryogen container arranged in use to contain a cryogen; wherein one of the at least one combustion prime mover and one of the at least one cryogenic prime mover operate simultaneously.

Viewed from a further aspect there is provided an aircraft comprising: the aircraft prime mover system of any of claims 15 to 26; and, a fuselage having a fore portion and an aft portion, wherein at least one of the at least one combustion prime mover and the at least one cryogenic prime mover is located in the aft portion of the fuselage.

Viewed from a still further aspect there is provided a use of a partial cryogenic fuel source in an aircraft comprising a plurality of prime movers for one of the plurality of prime movers.

Viewed from a still further aspect there is provided a use of a cryogenic source in conjunction with a non-cryogenic source to provide a portion of a fuel source for a plurality of prime movers in an aircraft.

Viewed from a still further aspect there is provided a use of a cryogen to increase electrical efficiency of a distributed propulsion network within an aircraft using the aircraft prime mover system of any of claims 15 to 26.

Viewed from a still further aspect there is provided a use of a cryogen in an aircraft for at least one of the following list: generating propulsion; increasing electrical efficiency; heat exchange functions; and, dehumidification functions.

Viewed from a still further aspect there is provided a multi-source aircraft propulsion arrangement comprising a cryogenic source and a combustion source wherein the cryogenic source and the combustion source may be selectively and independently operated to generate propulsive force for an aircraft; wherein the cryogenic source is arranged to be operated to generate propulsive force at a first stage, and wherein the combustion source is arranged to be operated to generate propulsive force at a second stage, the first stage being before the second stage.

Viewed from a still further aspect there is provided a method of generating propulsion in an aircraft, the method comprising: generating an initial propulsive force using a cryogenic source; and, generating a subsequent propulsive force using a combustion source.

Viewed from a still further aspect there is provided a n engine control arrangement operable to provide propulsion for an aircraft as described in any of the above claims.

Viewed from a still further aspect there is provided a method of operating an aircraft comprising an arrangement as described in any of the above claims.

### BRIEF DESCRIPTION OF THE DRAWINGS

One or more embodiments will now be described, by way of example only, and with reference to the following figures in which:

FIG. 1 shows a schematic of a current state of the art traditional propulsion arrangement and a schematic of a current state of the art hybrid electric boundary layer ingestion engine;

FIG. 2 shows a schematic of a superconducting hybrid electric boundary layer ingestion propulsion arrangement according to an example;

FIG. 3 shows a schematic of a multi-source aircraft propulsion arrangement in an aircraft according to an example;

FIG. 4 shows a schematic of a cryogenic source for use in a multi-source aircraft propulsion arrangement according to an example;

FIG. 5 shows a schematic of a multi-source aircraft propulsion arrangement according to an example;

FIG. 6 shows a schematic of a multi-source aircraft propulsion arrangement according to an example;

FIG. 7 shows a schematic of an air flight path from taxiing on the ground to cruising beyond the Environmental Boundary and returning to the ground;

FIG. 8 shows a schematic plan view of the aircraft and propulsion system arrangement according an example;

FIG. 9 shows a schematic side view of the aircraft and propulsion system arrangement according an example;

FIG. 10 shows a schematic of a multi-source aircraft propulsion arrangement according to an example; and,

FIG. 11 shows a schematic plan view of the aircraft and propulsion arrangement according to an example.

Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”. The invention is further described with reference to the following examples. It will be appreciated that the invention as claimed is not intended to be limited in any way by these examples. It will also be recognised that the invention covers not only individual embodiments but also combination of the embodiments described herein.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the spirit and scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

### DETAILED DESCRIPTION

An invention described herein relates to generating propulsion for an aircraft. A particular engine system for an aircraft involves multiple engines.

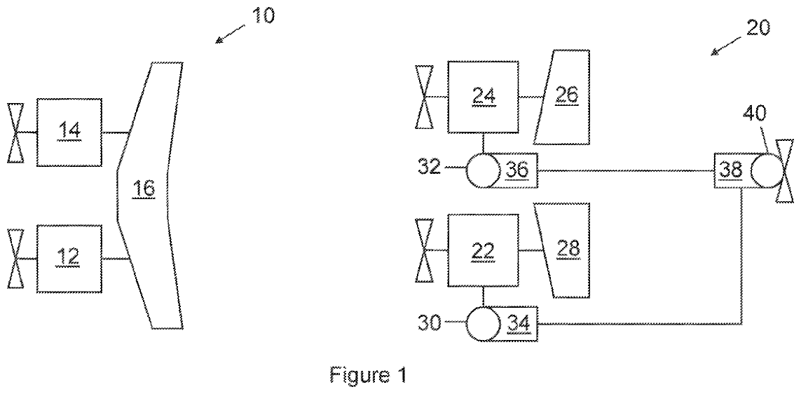

FIG. 1 shows a simple schematic of a current state of the art traditional propulsion arrangement 10 and a schematic of a current state of the art hybrid electric boundary layer ingestion engine 20. The current state of the art traditional propulsion arrangement 10 has a first combustion engine 12 and a second combustion engine 14. The two combustion engines 12, 14 are fed a combustible fuel source, contained within a fuel tank 16. The engines 12, 14, and associated propulsors, combine to ignite a fuel and air mix and eject this mix to provide propulsion for an aircraft. The combustible fuel source may be kerosene, biofuels or natural gas or the like.

The current state of the art hybrid electric boundary layer ingestion engine 20 has a first combustion engine 22 and a second combustion engine 24 each of which are fed a combustible fuel source, contained within respective fuel tanks 26, 28. The engines 22, 24 (and connected propulsors) operate as in the traditional propulsion arrangement 10 described above. The first combustion engine 22 is connected to a first generator 30, and the second combustion engine 24 is connected to a second generator 32. Each generator 30, 32 is connected to a generator control unit (GCU) 34, 36 respectively and each GCU 34, 36 is connected to a power electronic motor drive (PEMD) 38 and a motor 40. The motor 40 is connected to a propulsor for providing propulsion for an aircraft. The combustible fuel source may be kerosene, biofuels or natural gas or the like.

Boundary layer ingestion (BLI) has been shown to have the potential to reduce aircraft fuel burn by as much as 8.5% compared to aircraft currently flown. BLI enables engines to lower their workload and, as such, reduce the fuel consumption of the engine. Electrical machines, such as PEMD 38, motor 40 and the connected propulsor, have a better tolerance to aerodynamic distortion than a combustion engine 12, 14 and as such are more suited to BLI.

Both the arrangements shown in FIG. 1 may be used in a distributed propulsion arrangement. Distributed propulsion arrangements enable elements of the engine arrangement 20 to be located at a distance to one another. This can, for example, enable the efficient electrical motor to be in a location suitable for BLI while the combustion engines are located in a different location.

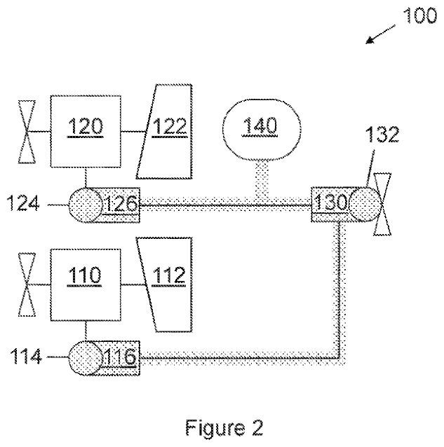

FIG. 2 shows a simple schematic of a multi-source aircraft propulsion arrangement 100. The propulsion arrangement 100, in the example shown in FIG. 2, has two combustion engines 110, 120 with two associated fuel tanks 112, 122. The engines 110, 120 are each connected to respective propulsors for generating propulsion in an aircraft. The engines 110, 120 are each connected to respective generators 114, 124 and the generators 114, 124 are each connected to a respective GCU 116, 126. The GCUs 116, 126 are connected to a PEMD 130 and a motor 132. The motor 132 is connected to a propulsor for generating propulsion in an aircraft. The arrangement 100, shown in FIG. 2, differs from the arrangement 20, shown in FIG. 1, by the presence of a cryogenic source 140.

The arrangement 100, shown in the example of FIG. 2, stores a cryogenic substance in the cryogenic source 140 which may be supplied to various elements of the arrangement 100. The cryogenic substance may be supplied to the electrical conduit between the generators 114, 124 and GCUs 116, 126 and the PEMD 130 and motor 132. The electrical conduit transfers electrical power more efficiently when the conduit is cooled by the cryogenic substance. Additionally cryogenic elements have the potential for lower mass than non cryogenic elements therefore enabling a lower empty mass of the aircraft further improving aircraft efficiency.

Herein terms such as “cryogen”, “cryogenic substance” and “cryogenic source” will be used interchangeably to refer to the actual substance that is of a cryogenic temperature. Such a substance would in most arrangements be contained within a tank or container or the like. A cryogenic temperature clearly depends on the substance in question however cryogenic behaviour has been observed in substances up to −50° C. Therefore, cryogenic temperature is taken herein to refer to temperatures below −50° C.

The arrangement 100, shown in FIG. 2, enables efficient use of distributed propulsion. Although distributed propulsion may be used in FIG. 1, there are significant electrical losses encountered in the electrical conduit linking the generators 30, 32 to the motor 40. The combustion engines 22, 24 of FIG. 1 are often located under the wings while the motor 40 is located near the tail of the aircraft. As such, transfer of electrical power through an electrical conduit located along the body of the aircraft is required: the longer the conduit, the larger the losses.

In a particular example of the novel arrangement shown in FIG. 2, the electrical conduit may be cooled, significantly cooled or rendered superconducting via a heat exchange function of the cryogenic substance. A superconducting arrangement overcomes a significant drawback of the arrangement of FIG. 1 in that the transfer of electrical power, which may be along or through the fuselage for wing mounted engine aircraft, may lead to large electrical losses and therefore increase the requirement for combustion of fossil fuels (or fossil fuel substitutes such as synthetic kerosene) to account for such losses. Typical systems of the arrangement shown in FIG. 1 have transfer efficiencies of the order of 80-90%.

A superconducting electrical system has a highly efficient transfer of electrical energy, and therefore less electrical loss in comparison to a non-cooled or a non-superconducting system. A superconducting electrical system accordingly has a significantly reduced requirement for additional combustion of fossil fuels in comparison to a non-superconducting system. The same type of benefit can be found, though to a lesser extent, for a cooled but not necessarily superconducting system. As such, use of a cryogen reduces required combustion in an aircraft for a predetermined level of propulsion.

The arrangement 100 shown in the example of FIG. 2 may have a cryocooler so as to maintain cryogenic conditions within the cryogenic source 140. The cryogenic substance may be any of liquid hydrogen (LH₂) or liquid nitrogen (LN) or Liquid Helium (LHE) or Liquid Natural Gas (LNG) or the like. The efficiency gained via the use of such a cryogenic substance in an arrangement, as shown in FIG. 2, is in the region of 5% or more for a comparable electrical system architecture, as shown in FIG. 1.

In a preferred embodiment of the arrangement of FIG. 2, the cryogenic source 140 is a bulk source which contains a bulk consumable cryogen due to the mass and energy penalty associated with inclusion of a cryocooler in an aircraft.

In an example, the unconventional arrangement 100 combines the use of a fossil fuel with the use of both H₂ and LH₂. The H₂ can be used as a fuel in combustion to provide propulsion. There is, therefore, disclosed herein a multi-source aircraft propulsion arrangement providing a number of benefits for an aircraft system.

The combination of fuels complements a tube and wing configuration for storage tanks for the multiple sources. The use of the cryogenic fuel reduces emissions (in comparison to burning fossil fuels) and, as partly described above, the cryogenic source may be used to support secondary functions such as inducing superconducting phenomena as well as cooling elements prone to producing or reducing friction. These benefits combine to provide a highly efficient system wherein reduction of emissions as high as 30% may be achieved. Higher reduction percentages may also be available using the presently disclosed system.

By using a combination of fuel types, the drawbacks associated with overly large tanks of H₂ or LH₂ (in comparison to pure fossil fuel tanks) is overcome. Tanks of H₂ or LH₂ may be appropriately sized and arranged within the fuselage or along the wings of an aircraft. As common designs locate the combustion engines under the wings of an aircraft, the H₂ or LH₂ tank/s may be located in the fuselage while the fossil fuel tanks are located on the wings, near the combustion engines. This arrangement is highly spatially advantageous.

In an alternate arrangement, the combustion engines may be located between the H₂ tank/s and the fossil fuel tank/s, which may be on the aft fuselage. This arrangement attempts to optimise the distance over which the fossil fuel and H₂ must be transported prior to use in combustion. Reduction in transport of the cryogen is important to reduce boil off of the cryogen.

By using a combination of fuel types, the total amount of fossil fuel (or, and references to fossil fuel throughout should be seen to include, fossil fuel substitute) combusted for a predetermined journey is reduced. This clearly has a beneficial impact via reduction of harmful emissions associated with fossil fuel combustion.

By introducing a cryogenic source 140 to the arrangements shown in FIG. 1, the cryogenic substance may be fed to the combustion engines 110, 120 to provide a thermal exchange function. In an example, the cryogenic substance may be converted from for example LH₂ to H₂ at which point the H₂ can be combusted to provide propulsion.

The vaporised cryogen may be combusted in the combustion engines 110, 120 alongside, or separately from, the fossil fuel (or substitute). Indeed, in the example wherein the engines 110, 120 switch from one feed (e.g. kerosene) to another (e.g. H₂), combustion should occur using both fuels to ensure a smooth transition from combustion of one fuel to the other. Alternatively, for example, a two-stage combuster could be used to provide separate combustion of fuels. Size benefits may, however, be gained using a smaller single stage combustor.

Further benefits may also be provided by the arrangement of FIG. 2. The cryogenic substance may be fed to, for example, a power unit to enable production of energy for use in propulsion. The power unit may be, for example, a fuel cell for generating electrical energy for operating a motor, for example. The power unit may be a combustion engine powered from hydrogen (as described above) which may or may not produce a propulsive force directly.

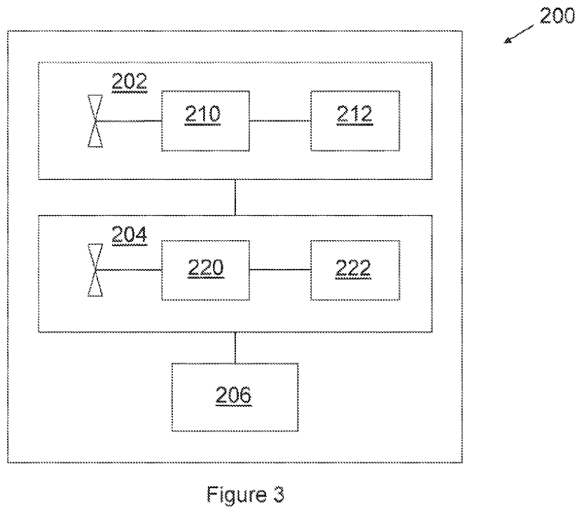

FIG. 3 shows a simple schematic of a multi-source aircraft propulsion arrangement in an aircraft 200 according to an example. The aircraft 200 has a combustion propulsion system 202 and a cryogenic propulsion system 204. In an example, the aircraft 200 may have an environmental control system 206. The combustion propulsion system 202 has a combustion engine 210, a combustion source 212 and a propulsor, as previously described. The cryogenic propulsion system 204 has a cryogenic engine 220, a cryogenic source 222 and a propulsor, as previously described. The environmental control system 206 may perform numerous functions such as air supply, thermal control and cabin pressurization for crew and passengers.

Rather than being connected to a series of propulsors, the combustion engine 210 and cryogenic engine 220 may additionally or alternatively be connected to fluid actuators. The term propulsor may be used to refer to a fluid actuator which may be the case where the propulsor is providing a force not in the direction of flight.

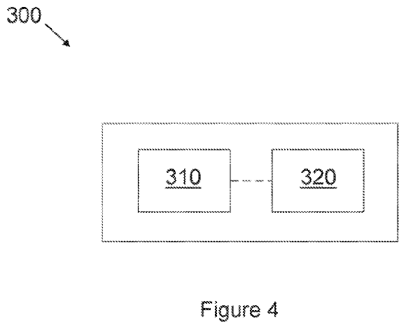

FIG. 4 shows a simple schematic of a cryogenic source 300 for use in a multi-source aircraft propulsion arrangement according to an example. The cryogenic source 300 has a gaseous source 310. The cryogenic source 300 may have, additionally or alternatively, a liquid source 320. The cryogenic source 300 may have a valve or series of values to enable controllable release of the gaseous source 310 and the liquid source 320. In this way, transport of the gaseous source 310 and the liquid source 320 to other elements in the aircraft may be controlled.

In the example wherein the cryogenic source 300 has both a gaseous source 310 and a liquid source 320, the cryogenic source 300 may have a conduit providing fluid communication between the gaseous source 310 and the liquid source 320. The conduit may enable boil-off from the liquid source 320 to collect in the gaseous source 310.

As described earlier, the gaseous source 310 and liquid source 320 may be in fluid communication with components external to the cryogenic source 300. These components may include combustion engines, power units, fuel cells and the like. Components may also be friction reducing components such as bearings, or components requiring cooling to improve efficiencies within the aircraft.

In an example, the gaseous source 310 is in fluid communication with a combustion engine to provide H₂ (or the like) to the engine for combustion to provide propulsion. This combustion engine may be a combustion engine that is also fed by fossil fuel to provide an air, fossil fuel and gaseous source 310 mix to the combustion engine. Alternatively or additionally, it may feed a separate combustion engine to the combustion engines that are fed by fossil fuels.

In an example, the fluid source 320 is in fluid communication with a power unit such as a fuel cell to generate energy. In an example, the liquid source 320 may additionally or alternatively be used to provide a heat exchanger function. For example, the fluid source 320 may be in fluid communication with elements that are advantageously cooled such as electronics, a superconducting arrangement or friction-reducing elements such as bearings within an engine arrangement. In present arrangements, engines generating thrust are air and/or oil-cooled which may lead to losses which can be overcome using a cryogen to cool engines instead, as such cryogen cooling is more effective.

Alternatively or additionally, the heat exchange function may be provided for the compression stages of a combustion engine. Cooling of a compressor stage allows access to higher compression ratio and therefore increases the effectiveness of the combustion engine total cycle. Cooling of a compressor also increases the compressor pressure ratio for a given combustor inlet temperature reducing the emissions of a combustion engine. The fluid source 320 may also be used to dehumidify air, and so provide an environmental control or for the inlet supply of a fuel cell. Dehumidifying air in the inlet supply of a fuel cell advantageously prevents water droplets freezing and therefore blocking pathways into or within the fuel cell.

When used so as to provide a heat exchanger function, the temperature of the liquid source 320 increases. The liquid may transition to a gaseous phase. The gas may be routed to a cooler to be condensed into liquid form. The gas may alternatively or additionally be routed to a combustion engine to be combusted. The selection of whether the gas is condensed or combusted may be controlled by a control unit which may observe the requirement for additional combustion against the requirement for additional cryogenic reserves or appropriate stoichiometric ratio.

When providing a heat exchange function, the liquid cryogen may be fed through a closed-loop high temperature superconducting (HTS) system, such as via a coaxial feed, before being returned to the bulk tank or to a cooler (for example, a cryocooler), if one is required for condensing the cryogen to a liquid.

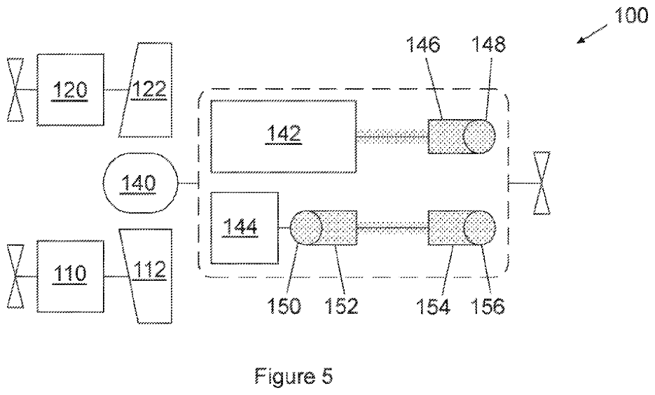

FIG. 5 shows a simple schematic of a multi-source aircraft propulsion arrangement 100 according to an example. Features of FIG. 5 that have been described previously in relation to other figures have the same numerals and, for improved readability, may not be described in detail here.

The arrangement 100 has a first combustion engine 110 and a second combustion engine 120 that are respectively fed by a first associated fuel tank 112 and a second associated fuel tank 122. The arrangement 100 has a cryogenic source 140. The cryogenic source 140 in the example shown is arranged so as to supply a fuel cell 142 and/or a third combustion engine 144.

The cryogenic source 140 supplies a liquid cryogen to the fuel cell 142 for generation of electrical power. The electrical power is conducted along a conduit to a PEMD 146 and a motor 148 to subsequently generate propulsion. The conduit along which the electrical power is conducted may be supercooled by cryogen supplied by the cryogenic source 140 to reduce transmission loses (as described earlier). Other heat exchange functions may also be performed on the PEMD 146 and the motor 148 by a cryogen supplied by the cryogenic source 140.

The cryogenic source 140 supplies a gaseous source, which may have formed from boil off from the liquid cryogen, to the combustion engine 144. The gaseous source may alternatively or additionally form from the heat exchanger function performed by the liquid source on the conduit between the fuel cell 142 and the PEMD 146 and the motor 148. In an example, the heat exchanger function is provided by an intercooler.

The combustion engine 144 which is fed with a gaseous source from the cryogenic source 140 is connected to a generator 150 and a GCU 152. The generator 150 and GCU 152 are connected to a PEMD 154 and a motor 156 for generating propulsion. The generator 150, GCU 152, PEMD 154, motor 156 and conduit linking these elements may be cooled by a heat exchange function performed by the liquid cryogen supplied by the cryogenic source 140. This improves electrical efficiencies as previously described.

The energy from both the combustion engines 110, 120 fed by the two associated fuel tanks 112, 122 and the motors 148, 156 may be routed to propulsors to generate propulsive energy. In the example shown in FIG. 5, there are three propulsors; one associated with each of the two combustion engines 110, 120 fed by fuel tanks 112, 122 and one associated with the cryogenic source 140. In other arrangements, there may be a different number of propulsors. The number and arrangement of propulsors is preferentially chosen to allow efficient routing of e.g. electrical power through the aircraft.

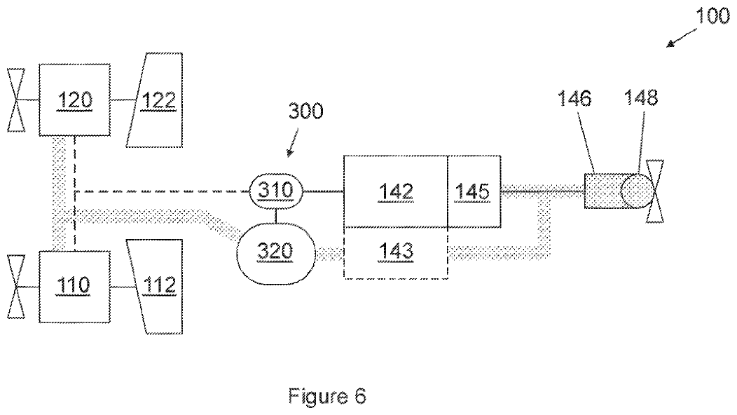

FIG. 6 shows a simple schematic of a multi-source aircraft propulsion arrangement 100 according to an example. Features of FIG. 6 that have been described previously in relation to other figures have the same numerals and, for improved readability, may not be described in detail here.

The arrangement 100 has a first combustion engine 110 and a second combustion engine 120 that are respectively fed by a first associated fuel tank 112 and a second associated fuel tank 122. The arrangement 100 has a cryogenic source 300 which has a gaseous source 310 and a liquid source 320. The cryogenic source 300 is in fluid communication with the combustion engines 110, 120 to generate propulsion as well as a fuel cell, and battery management system, 142 to generate and manage electrical energy produced using the liquid source 320.

The arrangement 100 optionally has a cryocooler 143 for performing heat exchange to condense vapourised liquid cryogen back into liquid cryogen. Use of cryocooler 143 may reduce the amount of cryogen that is ultimately lost during a particular flight, and as such can reduce the running costs of the arrangement 100. In an example of the arrangement 100 where there is no cryocooler 143 present, vaporised cryogen is returned to the bulk source to condense back to liquid form or is transported to a combustion engine to be combusted to provide propulsion. The combustion engine to which the vaporised cryogen is transported is preferably one of combustion engines 110, 120 though in some arrangements may be different combustion engine.

The gaseous source 310 of the cryogenic source 300 may be provided to one or both of the combustion engines 110, 120 in addition to or in place of the fuel provided by sources 112, 122 for combustion to generate propulsion. In an alterative arrangement 100, the gaseous source is provided to for example two other combustion engines (which may be located either side of the fuselage for balance) which operate exclusively on gaseous source 310 for combustion. For weight and efficiency considerations however, it is preferred that the gaseous source 310 is delivered to the combustion engines 110, 120 which also operate on fossil fuels.

The arrangement 100 may also have a series of batteries 145 to store energy in chemical form. This chemical energy may be deployed as electrical energy at some point to provide additional energy for conversion into propulsive force. The cryogenic source 300 may be used to provide heat exchange functions on a series of batteries so as to improve efficiencies of the batteries. The fuel cell 142 and series of batteries 145 may be connected to a PEMD 146 and a motor arrangement 148 via a connection which may be cooled by the cryogenic source 300, again to increase electrical efficiencies. As with previous arrangements, the PEMD 146 and motor 148 is connected to a propulsor.

The arrangement 100 may optionally include a connection between the cryogenic source 300 and the combustion engines 110, 120. A heat exchange function, as previously described, may be provided to elements within the engines 110, 120 such as friction-reducing bearings by the cryogenic source 300.

In a particular arrangement, the cryogenic source 300 is located in the rear fuselage of an aircraft. The cryogenic source 300 may be located behind the rear pressure bulkhead of the aircraft in a space which is not densely populated. The rear pressure bulkhead may advantageously act as a natural structural barrier and is already present in modern arrangements. Location of a fuel tank aft of the rear pressure bulkhead provides the advantage of gaseous isolation due to pressure differential with the cabin and therefore the ability to inert, evacuate or enable sufficient air changes in the tank compartment and distribution compartment. Another advantage is the crash worthiness due to the structural proximity of the rear bulkhead. Another advantage of this arrangement is the proximity to the propulsion system, boundary layer (centre or asymmetric) or pod-ed. Another advantage relates to location of the tank in comparison to the landing gear, for additional stability on landings etc. In modern arrangements of aircrafts, this space is the least efficiently used space within the aircraft. Furthermore, the location of the cryogenic source 300 in the rear fuselage of an aircraft provides an effective use of the interior volume of the aircraft. In particular, the cylindrical shape of the rear fuselage lends itself to a cylindrical (or spherical) shaped cryogenic source tank. A cylindrical (or spherical) shaped cryogenic source tank also beneficially results in low boil off of the cryogenic source held within the tank. Spherical tanks are the lowest mass solutions from a tank perspective.

Alternatively, the aircraft may have a wide fuselage, such as for example a “double-bubble” shape fuselage. A double bubble fuselage is, in contrast to the more usual circular fuselage cross section, formed from the shape of two intersecting circular shapes. The double bubble shape fuselage is a type of wide fuselage. The wide fuselage formation allows for a greater volume in the rear fuselage of the aircraft. As such, a larger tank can be provided with LH₂ within the aircraft. In this way, the aircraft may be provided with a greater amount of cryogenic source 300 to enable long range flights exclusively using the cryogenic source 300. This arrangement enables an aircraft to fly 2500 nm which is a considered a sufficiently long range mission for a medium haul aircraft. The storage for the cryogenic source 300 may be in a single tank, a partitioned tank or multiple tanks. The tanks can be extended under a pressure floor if required. This arrangement lends itself well to a two fuel cell propulsion system, which is installed in the rear fuselage.

The tanks may be distributed throughout the aircraft in a manner so as to controllably move or adjust the centre of gravity of the aircraft (and contents). Controlling the centre of gravity so as to be situated substantially over, for example, the landing gear will assist in prevention of instability during taxiing, take-off and landing. Furthermore, a more evenly balanced aircraft has a more efficient energy utilisation needing less trim (stabilising aircraft force) and a more efficient flight experience. As such, location of multiple tanks (or partitioned tanks or tanks) so as to control the centre of gravity is advantageous.

Advantages of the double-bubble arrangement when in combination with the disclosed propulsion system include the provision of sufficient volume for traditional aircraft ranges, such as single aisle 2500 nautical miles or more (comparable to A320 or B737). This then results in an environmentally friendly long haul aircraft being achieved. Other advantages include:
Traditional Twin Engine Configuration for ETOPs;
Segregation of hydrogen (or methane, ammonia, or other fuel) system from passenger cabin, where additionally fuel is not required to be routed to engines on the wings (however it could be as an option);
Safe location of fuel system for landing gear up landings;
Optimal location of hybrid propulsion components;
Boundary layer ingestion benefit; and,
Noise shielding benefit.

Many of these are safety benefits or efficiency benefits which are of significant interest in commercial flight systems. Though this may apply to the cryogenic source 300 such as LH₂, this may also be applied NH₄ fuel systems in order to ensure segregation of the ammonia.

The double-bubble fuselage also has additional efficiency benefits in relation to boundary layer ingestion, particularly benefitting from a favourable fuselage pressure distribution and dual boundary layer ingesting propulsors. This may be a horizontal double-bubble or a vertical double-bubble fuselage. The arrangement may have an axi-symmetrical design in relation to the BLI. In this example, the boundary layer is axi-symmetrically distributed, i.e. evenly distributed from an azimuthal perspective. In another example, the arrangement may have an asymmetrical arrangement, wherein the boundary layer is not evenly distributed from an azimuthal perspective. The boundary layer in an asymmetrical arrangement may be arrangement near the bottom of the fan.

The installation of the cryogenic source tank in this location of the fuselage has a relatively small impact on the used space of the fuselage and does not require an increase in the geometrical length of the fuselage. The cryogenic tank need not be as structurally complex as a gaseous tank by virtue of the relative pressures at which the tanks would need to maintained at: 1 to 3 bar for a liquid source as opposed to around 700 bar for a gaseous tank. Furthermore, with location in the aft fuselage and an appropriately located power unit and motor, the liquid cryogen need not run into the pressure cabin of the aircraft. Reducing the distance over which the gaseous source 310 and the liquid source 320 are transported also increases the overall safety of the arrangement 100.

Inclusion of the cryogenic source tank within the fuselage reduces the tank volume required on the wings of the aircraft. In turn, this beneficially enables the inclusion of high aspect ratio laminar flow wings in aircraft as well as fuselage-mounted landing gear. This occurs as the required combustion fuel resource volume is lower thereby requiring less wing internal volume enabling thinner wings and potentially no fuselage fuel tank. Furthermore, the lower total weight of fuel helps to offset the additional weight of the electrical propulsion system, rendering the arrangement 100 even more viable. In certain arrangements, there is no fossil fuel tank arranged on the fuselage of the aircraft. This reduces the drag associated with such location of a tank and in turn improves the efficiency of the arrangement 100.

The above disclosed arrangement enables a reduction of between 30-40% of fossil fuel-provided energy with this energy replaced by that produced from a cryogenic system. This energy split also lends itself well to gas turbine sizing and failure resiliency considerations (relating to Automatic Performance Reserve, the over-rated thrust of the engine to cover failure of a different engine), for both single and twin gas turbine engine arrangements. In the event that both gas turbines fail, the propulsor operated via the cryogenic source 300 will still be operative. Similarly, should the power unit fail, and cease producing electricity, the gas turbine or turbines may still generate power to drive the aircraft. In a preferred arrangement, the power unit produces electrical power only and the gas turbines or turbines generate power to drive the aircraft only.

A further advantage provided by the arrangement 100 shown in FIG. 6, is that the PEMD 146, motor 148 and connected propulsor have a good tolerance to aerodynamic distortion as described earlier and as such are suitable for use with BLI. The use of a cryogenic source to cool electrical conduits throughout the fuselage enables propulsors to be distributed across the fuselage without experiencing significant loss in electrical efficiencies. As such, this in turn enables highly efficient integration of a BLI system alongside a typical combustion system. A BLI system may have an inlet arranged to allow entry into the engines of slower boundary layer air flow. Using the slower boundary layer air means the engines are not required to work as hard, which reduces fuel consumption. Such an arrangement may be referred to as a boundary layer ingestion cryogenic engine. In total, the reduction of fossil fuel combustion possible using the arrangement of FIG. 6 with correctly integrated BLI is in the region of 40%. The engines 110, 120 in the arrangement 100 shown in FIG. 6 may be arranged so as to ingest non-laminar airflow. Non-laminar airflow is disrupted airflow which has a lower momentum than freely flowing air. Freely flowing air may enter engines which are, for example, located under the wings of an aircraft. Non-laminar airflow in contrast may have been disrupted by for example flowing over the fuselage of the aircraft. Non-laminar airflow may also occur due to disruptions in the passage of the airflow. Such disruptions may be caused by elements of the aircraft or by formation flying or the like, for example.

Furthermore, the use of a fuel cell to provide electrical power results in only the emission of H₂O, as opposed to harmful gaseous emissions produced by standard combustion engines. This H₂O may be captured and used within the aircraft as potable or non-potable H₂O. Capturing the H₂O also prevents formation of clouds via emission of water vapour, which in turn reduces radiative forcing created by the aircraft.

H₂O captured from the power unit 142 may be routed so as to be in fluid communication with the combustion engines 110, 120 of the arrangement 100. Water injection can be used to cool certain parts of a combustion engine so as to convert this heat energy into thrust or to enable more favourable exit conditions at the nozzle. This technique can be used to increase thrust for short periods when required. Additional thrust can sometimes be required for aircraft in hot and dry conditions and as such this technique may be advantageous for use in such an environment. Water injection may also be used to reduce harmful gaseous emissions of, for example, NOx. Water injection may also be used to reduce combustion and combustion exhaust temperatures.

In an example, the arrangement 100 may be optimised for performing flights according to the distance to be travelled. Such optimisation may take into account the following features:
(1) For aircraft which operations require energy levels which are higher than the energy capacity of the cryogen then this aircraft is equipped with both the Kerosene and Cryogen source.
(2) For aircraft which operate such that the onboard energy is less than or equal to the energy capacity of the cryogen that this aircraft is equipped for only cryogenic fuel and as such can be delivered without the capability for storing or necessarily using Kerosene.
   Such an approach can lead to a fleet of two types of aircraft which are, except for the fuel types used, almost entirely identical where one type of aircraft will be lower in mass and may utilize combustion engines optimized for cryogenic as opposed to mixed fuel. Therefore that type of aircraft will consume less energy for a given operating condition.

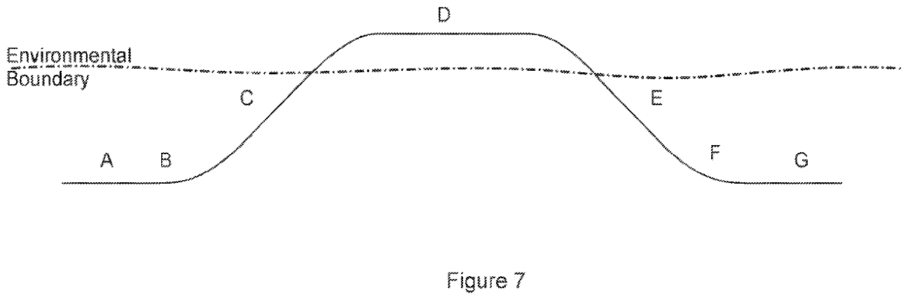

Other optimisations may include, for example, optimising the power production at different stages of a flight. FIG. 7 shows a simple schematic of an air flight path from taxiing on the ground to cruising beyond the Environmental Boundary and returning to the ground.

There are 7 identified stages of flight shown in FIG. 7 (though in practice there may be many more, these have been highlighted for the purposes of illustration of an embodiment of the present disclosure):

A indicates taxiing of the aircraft on the ground prior to take off;

B indicates take off of the aircraft;

C indicates climbing of the aircraft through the Environmental Boundary towards a cruising altitude;

D indicates cruising of the aircraft having reached cruising altitude and cruising speed beyond the Environmental Boundary;

E indicates descent of the aircraft back through the Environmental Boundary;

F indicates landing of the aircraft; and,

G indicates taxiing of the aircraft having landed and eventual cessation of movement.

The Environmental Boundary shown in FIG. 7 is a schematic representation of the altitude and/or conditions at which persistent contrails are formed by the aircraft during flight. The precise altitude of the Environmental Boundary varies with engine inlet and exit conditions, changes in pressure, temperature and humidity.

In an example of optimisation of the generation of thrust during flight stages, thrust for taxiing and take off stages A and B may be exclusively produced from the cryogenic source 300 which may be provided by either or both of the liquid source 320 or the gaseous source 310. Thrust for the climbing stage C may be generated also using the cryogenic source 300. Once the aircraft is airborne, passes through the Environmental Boundary and is in cruise stage D, the operation may switch to combustion via fossil fuels. Descent stage E and landing stage F may also operate exclusively using the cryogenic source 300. Thrust for the taxiing stage G may be supplied exclusively by the cryogenic source 300.

Numerous advantages are provided by this division of production of thrust. The production of harmful gaseous emissions is performed above ground level, remote from houses or places of business etc. Furthermore, during descent the combustion engines 110, 120 may be in idle mode with sufficient rotation of the engine core provided so as to prevent locking. This mode of operation removes the noise associated with combustion of fossil fuels in the combustion engines 110, 120 and, as such, landing may be performed with significantly reduced noise levels. Combustion of fossil fuel in the combustion engines, rather than the cryogenic source 300, to provide propulsion beyond the Environmental Boundary reduces the production of contrails which may occur when, for example, creating propulsion via hydrogen. This may in turn reduce radiative forcing created by the aircraft.

The arrangement 100, may be operable with all engines simultaneously or individually and any combination thereof. This flexibility would enable a pilot to optimise the engine choice for the stage of flight. This would also not restrict a pilot to a particular engine if, for example, a change in thrust is desired at any stage in a flight to overcome, or adapt to, changes in flight conditions.

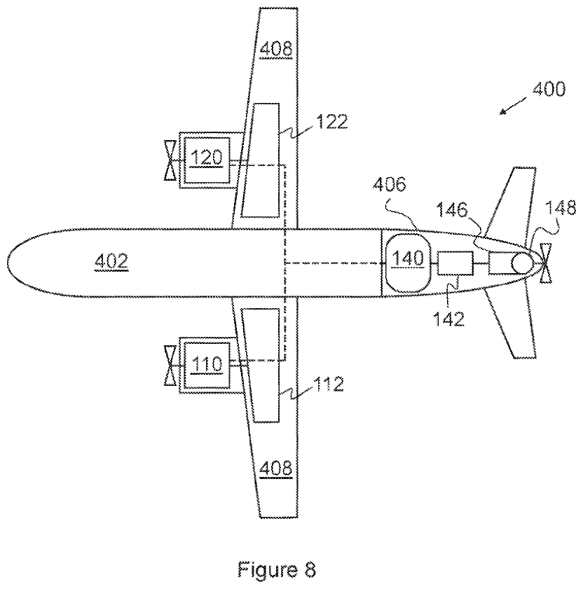

FIG. 8 shows a simple schematic of an aircraft 400 according to an example. The aircraft 400 shown in FIG. 8 is shown in a plan view. Features of FIG. 8 that have been described previously in relation to other figures have the same numerals and, for improved readability, may not be described in detail here.

The aircraft 400 in the example shown in FIG. 8 has a fuselage and cabin portion 402 and an unpressurized aft-fuselage 406. Components of the multi-source aircraft propulsion arrangement are shown positioned within the aircraft 400. The combustion engines 110, 120 are arranged near the wings 408 of the aircraft 400. The cryogenic source 140 is contained within the aft-fuselage 406 of the aircraft 400. A conduit between the combustion engines 110, 120 and the cryogenic source 140 is also shown in dashed lines.

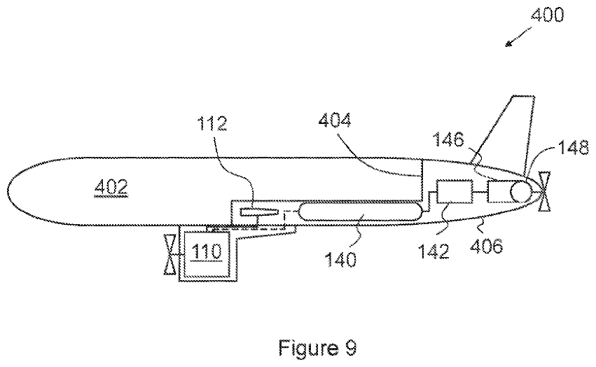

FIG. 9 shows a simple schematic of an aircraft 400 according to an example. The aircraft 400 shown in FIG. 9 is shown in a side-on sectional view. Features of FIG. 9 that have been described previously in relation to other figures have the same numerals and, for improved readability, may not be described in detail here.

The aircraft 400 shown in FIG. 9 has a fuselage and cabin 402 and after-fuselage 406 as shown in FIG. 8. FIG. 9 also illustrates a pressure boundary 404 between these portions of the aircraft 400. The pressure floor of the aircraft may form the pressure boundary 404. In some aircraft, the wing may pass through the pressure boundary 404.

The cryogenic source 140 in the example shown in FIG. 9 is arranged under the pressure boundary 404. This may compromise cargo room however this increases the available room for the cryogenic source 140 in comparison to wing and fuselage based tank arrangements. Therefore, the cryogenic source 140 may be under the pressure floor rather than e.g. in the aft-fuselage 406.

In specific examples of the present arrangement, the arrangement 100 may include a magnetic transmission. In a system using a high speed electrical motor, it is advantageous to use a gearbox to slow the shaft speed to enable use with a fan. In certain examples, planetary gearboxes may be used in place of magnetic gearboxes. Such gearboxes use complex toothed gear arrangements which can be maintenance intensive and heavy. Magnetic gearboxes may be used to overcome some of the drawbacks associated with planetary gearboxes. In an example, the cryogenic source may enable supercooling of the gearbox to ensure the magnetic gearbox is cooled to a superconducting magnetic state to improve efficiency of the gearbox. The gearbox size may also be reduced by such a magnetic gearbox.

In specific examples of the present arrangement, the arrangement 100 may be connected to an electric motor which has a power rating in excess of 1.5 MW, 2 MW or 2.5 MW or the like. This may provide up to for example ⅓ of the thrust required for a 100-160 seater aircraft in cruise mode. In a different example, the arrangement 100 may be connected to eight 250 kW motors. The size and number of motors may be selected according to the flights to be performed by the aircraft in which the arrangement 100 is integrated.

The functions of the fuel cell, PEMD and electrical motor can be combined within a fuel cell motor drive. In this way spatial requirements are reduced and the overall system is simplified, reducing the need for a separate distribution system between these components. In such a system, current for the (superconducting) motor windings is supplied by the fuel cell stack as an integrated part of the machine such that current is supplied to field windings integrated within the fuel cell motor drive to drive a rotor. This rotor can then be used to provide rotational power (or torque) to a BLI fan.

Further this system can be expanded to provide pressurized air (e.g. for cabin services or heat exchange) as well as a turbine or compressor to provide cooling air for the fuel cell stacks. It can therefore be used as part of an integrated environmental control system.

In an example, a method for providing propulsion in an aircraft as described herein may include the steps of:

A. generating an initial propulsive force using a cryogenic propulsion source; and,

B. generating a subsequent propulsive force using a combustion propulsion source.

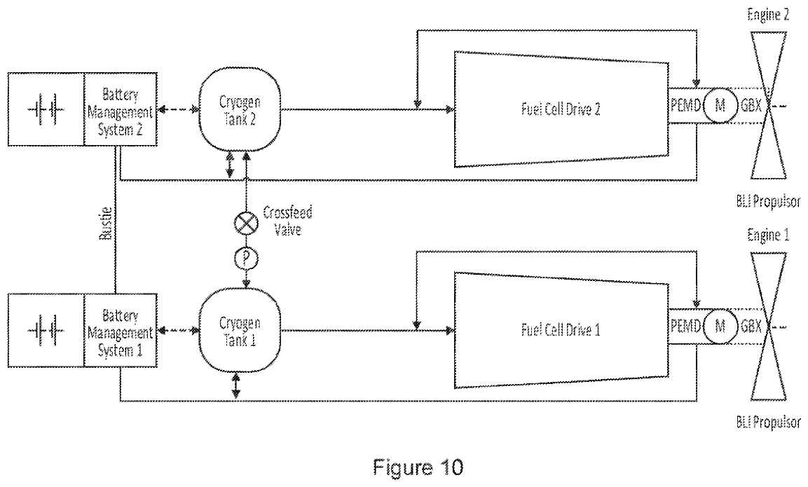

FIG. 10 shows a simple schematic of a multi-source aircraft propulsion arrangement 100 according to an example. In the example shown in FIG. 10, the arrangement is a two fuel cell propulsion system. The system shown has two cryogen tanks, each connected to a respective battery management system. The figure illustrates cryogen tank 1 connected to battery management system 1 and cryogen tank 2 connected to battery management system 2. Battery management system 1 is connected to battery management system 2 via a bus. The cryogen tanks are also connected via a cross feed valve.

The cryogen tanks are connected to respective fuel cell drives. Cryogen tank 1 is connected to fuel cell drive 1. Cryogen tank 2 is connected to fuel cell drive 2. The two fuel cell drives are connected to respective engines. As illustrated, fuel cell drive 1 is connected to a PEMD, a motor and the propulsor of engine 1. Fuel cell drive 2 is connected to a PEMD, a motor and the propulsor of engine 2. The PEMD of engine 1 is connected to battery management system 1 by a bus. The PEMD of engine 2 is connected to battery management system 2 by a bus. The cryogen tanks are connected respectively to these buses, to increase electrical efficiency. The cryogen tanks are also respectively connected to the PEMDs. The cryogen may be used to power both fuel cells as well as provide cryogenic advantages associated with electrical efficiency and the like as described in detail above. The propulsors of the engines are BLI propulsors, with the associated advantages of this arrangement described in detail above.

This system can be installed in the rear fuselage of the aircraft with, for example, a single large cryogenic fuel tank alongside the system as illustrated in FIG. 10. The large cryogenic fuel tank may be, for example, installed in a double-bubble fuselage of an aircraft for example behind the rear pressure bulkhead of the aircraft.

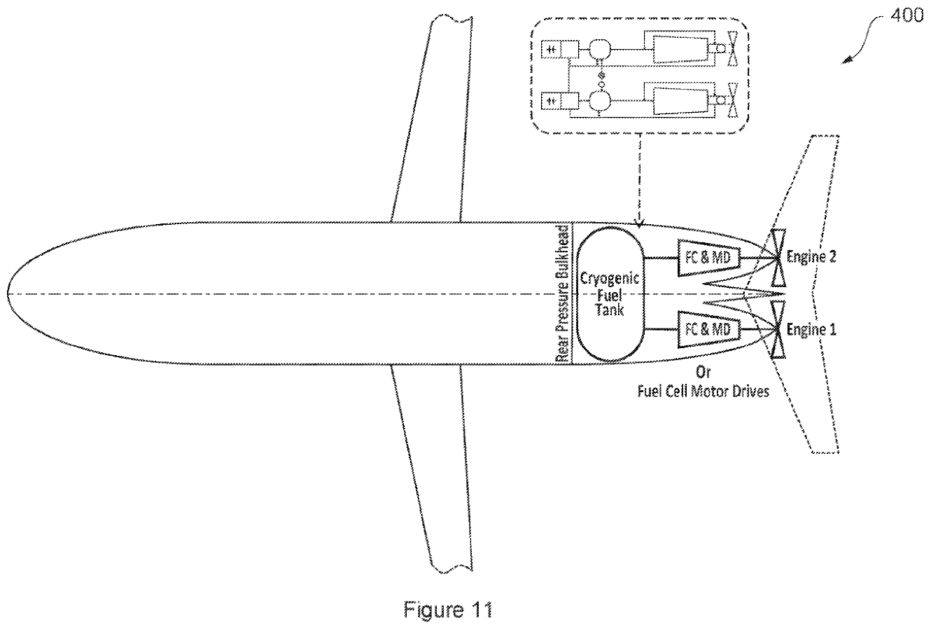

FIG. 11 shows the system of FIG. 10 in place in a wide fuselage of an aircraft 400, according to an example. The fuselage of FIG. 11 may be a double bubble fuselage. The large cryogenic fuel tank is connected to a first fuel cell and a second fuel cell. Each of the fuel cells may be connected to a motor or a motor drive. Each of the motors are then connected to a respective engine (shown as engine 1 and engine 2) at the rear of the aircraft 400. As discussed, this may allow for boundary layer ingestion and the associated advantages described above.

In an example, the wide fuselage aircraft may have two cryogenic prime movers. In another example, the wide fuselage aircraft may have two combustion prime movers.

As used herein, the term cryogenic source or cryogen is deemed to be a non-restricting term and so may refer to any of liquid hydrogen, liquid natural gas, liquid nitrogen, liquid helium, and the like. The cryogen need not necessarily be only one of the above list. In an example wherein a number of cryogens are used, not all cryogens need to be a combustible fuel. In an example, H₂ may be used as an alternative fuel source, while cryogenic cooling is supplied by liquid nitrogen.

As used herein, the term fossil fuel may is deemed to be a non-restricting term and so may refer to any of kerosene, biofuels, synthetic kerosene and the like. The fossil fuel need not necessarily be only one of the above list. The term “non-cryogenic source” may also refer to fossil fuels are described herein.

Although the application described herein relates to propulsion systems for aircraft it may also be applied to application where energy generation is required without harmful emissions, with lower fossil fuel consumption and/or alongside production of water.

These applications may include automotive, space, domestic or commercial and so forth.

Additional benefits are provided by the presently disclosed system by virtue of the removal of oil from gas turbines and the like which leads to a reduction in particulates and NMVOCs due to atomised engine oils. This is known as aerotoxic syndrome. This is one of the main reasons not to feed bleed air any more from gas turbine engines; i.e. due to the health benefits.

A further benefit of the use of cryogenic fuels as disclosed herein is that microbe colony formation which occurs in existing aircraft kerosene fuel tanks is avoided. The cleaning of such tanks currently requires detergent cleaners which are somewhat environmentally damaging. In some cases this cleaning may be after each long haul flight. Therefore the reduction in cleaning has further environmental benefits.

1.-51. (canceled)

52. An aircraft propulsion arrangement comprising a cryogenic source, wherein the cryogenic source may be selectively and independently operated to generate propulsive force for an aircraft by combustion and/or to generate propulsive force for an aircraft by electrical energy generation.

53. The aircraft propulsion arrangement of claim 52, wherein the cryogenic source may be operated to generate propulsive force for an aircraft by combustion and to generate propulsive force for an aircraft by electrical energy generation simultaneously.

54. The aircraft propulsion arrangement of claim 52, wherein the cryogenic source comprises a cryogenic resource,
wherein the cryogenic source is arranged to contribute cryogenic resource to an aircraft engine array to generate propulsive force for an aircraft by combustion and to generate propulsive force for an aircraft by electrical energy generation.

55. The aircraft propulsion arrangement of claim 52, further comprising a combustion source which may be operated to further generate propulsive force for an aircraft via combustion.

56. The aircraft propulsion arrangement of claim 55, wherein the cryogenic source and the combustion source may be operated simultaneously.

57. The aircraft propulsion arrangement of claim 55, wherein the combustion source comprises a combustion resource, and
wherein the cryogenic source and the combustion source are arranged to contribute respective resources to an engine array to generate propulsive force.

58. A cryogenic system in an aircraft prime mover system arranged to drive a prime mover as part of a distributed propulsion system, wherein the cryogenic system comprises a cryogen container arranged to contain a cryogen.

59. The cryogenic system of claim 58, wherein the cryogen is arranged to provide a heat exchanger function.

60. The cryogenic system of claim 58, wherein the cryogen is arranged to provide a dehumidifier function.

61. The cryogenic system of claim 58, wherein
the aircraft prime mover system comprises at least one element;
the cryogen container is in fluid communication with the at least one element;
the cryogen is controllably moveable from the cryogen container to be in thermal contact with the at least one element, and
wherein the at least one element is at least one of:
a superconducting arrangement;
an engine bearing; and,
a conduit.

62. The cryogenic system of claim 58, wherein the cryogen is a liquid and wherein the cryogenic system comprises:
a storage tank for storing vaporized liquid formed from the liquid cryogen, the storage tank being in fluid communication with the cryogen container; and,
a conduit for providing fluid communication between the storage tank and a combustor for combusting the vaporized liquid.

63. The cryogenic system of claim 58, comprising a power unit for providing electrical energy generation,
wherein the cryogen container is in fluid communication with the power unit.

64. The cryogenic system of claim 63, comprising a passage that links the cryogen container with the power unit,
wherein the passage provides fluid communication between the cryogen container and the power unit such that the cryogen may pass from the cryogen container to the power unit through the passage.

65. The cryogenic system of claim 58, further comprising a cryocooler arranged to condense vaporized cryogen.

66. A multi-source aircraft propulsion system comprising a cryogenic source and a combustion source wherein the cryogenic source and the combustion source may be selectively and independently operated to generate propulsive force for an aircraft;
wherein the cryogenic source is arranged to be operated to generate propulsive force at a first stage, and wherein the combustion source is arranged to be operated to generate propulsive force at a second stage,
the first stage being before the second stage.

67. The multi-source aircraft propulsion system of claim 66, wherein the first stage is a taxi and/or take off stage.

68. The multi-source aircraft propulsion system of claim 66, wherein the second stage is a cruising stage.

69. The multi-source aircraft propulsion system of claim 66, wherein the cryogenic source is arranged to be operated to generate propulsive force during a third stage,
the third stage being a descent and/or landing stage.
